(19) United States
(12) Patent Application Publication
(10) Pub. No.: US 2005/0216317 A1
(43) Pub. Date: Sep. 29, 2005

(54) System and method for providing an airline variable routed capacity management system

(75) Inventors: John M. Medellin, Highland Village, TX (US); William Seton Diffenderffer, Dallas, TX (US)

Correspondence Address: DUKE W. YEE, YEE AND ASSOCIATES, P.C., P.O. BOX 802333, DALLAS, TX, 75380, US

(73) Assignee: International Business Machines Corporation, Armonk, NY (US)

(21) Appl. No.: 10/809,769

(22) Filed: Mar. 25, 2004

(51) Int. Cl. G06F 17/60

(52) U.S. Cl. 705/6

(57) ABSTRACT

A system and method for providing an airline variable routed capacity management system. With the system and method, a user, at time of booking, identifies only the departure and arrival airports, the dates of departure and return flights, and the travel window, i.e. the amount of travel time the user is willing to endure to travel between the departure and arrival airports, or vice versa. At time of booking, there is no blocking of travel lanes since there is no reservation of seat assignments or flights but only the guarantee that the airline will provide some flight itinerary between the departure and arrival airports that meets the travel window on the departure and return dates. The particular flights or seat assignments are not identified and are not reserved. At some time prior to the departure date, the user may again access the system of the present invention to obtain a listing of flight itineraries that meet the travel window on the dates and between the cities identified by user at booking. Based on the listing of possible flight itineraries, a user may select one of the flight itineraries and then obtain their seat and flight assignments based on the flight itinerary selected.

### BACKGROUND OF THE INVENTION

1. Technical Field

The present invention is directed to an improved computing system. More specifically, the present invention is directed to a system and method for providing an airline variable routed capacity management system.

2. Description of Related Art

Currently, if an individual wishes to obtain flight arrangements for traveling from a departure airport to a destination airport, the individual must obtain a firm booking of a particular seat on a flight or flights. That is, the individual blocks a lane of travel to be used by himself. A particular seat on a particular flight is guaranteed and reserved for his/her personal use. No other individual may make use of this seat on this flight until the individual himself/herself gives up the seat.

Because the current mechanisms require each individual traveler to book a particular seat on a particular flight, often times flights have unused or idle capacity, i.e. seats that go unreserved. These idle capacity seats are often provided at a discount by either the airline or discount vendors, e.g. TRAVELOCITY™ or EXPEDIA™, which offer discounts in order to fill seats on flights. Even with such discount vendors, however, the individual traveler must book their flight by blocking a lane, i.e. reserving a designated seat on a designated flight or flights. Even with such discount vendors, seats on flights may still remain idle. Thus, there is an incentive for airlines to find an improved mechanism for filling idle capacity so as to maximize profitability or reduce losses.

In addition, the traveler himself/herself wishes to obtain travel services at as low a cost as possible. Currently, the only manner by which a traveler may obtain reduced cost travel services from airlines is to make use of discount vendors which offer the travel services at discounted costs but not at the lowest cost feasible for the airlines. Thus, travelers have a desire to make use of an improved mechanism for obtaining low cost travel services.

### SUMMARY OF THE INVENTION

The present invention provides a system and method for providing an airline variable routed capacity management system. The system and method of the present invention provide a new class of travel referred to as the variable class (“V” class) or variable fare (“V” fare) flight service. This “V” class of flight service avoids blocking of travel lanes and instead permits booking of flights based on travel windows.

With the system and method of the present invention, a user, at time of booking, identifies only the departure and arrival airports, the dates of departure and return flights, and the travel window, i.e. the amount of travel time the user is willing to endure to travel between the departure and arrival airports, or vice versa. At time of booking, there is no blocking of travel lanes since there is no reservation of seat assignments or flights but only the guarantee that the airline will provide some flight itinerary between the departure and arrival airports that meets the travel window on the departure and return dates. The particular flights or seat assignments are not identified and are not reserved.

At some time prior to the departure date, the user may again access the system of the present invention to obtain a listing of flight itineraries that meet the travel window on the dates and between the cities identified by user at booking. The identification of these flight itineraries may be made based on the criteria set by the booking of the travel window as well as information obtained from airline computing systems that identify available seats on flights, flight path information, travel time information, and the like.

This listing of available flight itineraries that meet the criteria set by the user during booking of the travel window may identify reduced prices or discounts to be applied to the price associated with these flight itineraries. The particular amount of reduction in the price or discount may be based, for example, on yield and pricing information obtained from airline computing systems.

In addition, flights that do not fall within the travel window but are within a particular tolerance of the travel window may be provided as options with additional discounts associated with them. In this way, the user may be “enticed” into adjusting their original travel criteria to take advantage of additional travel discounts.

Based on the listing of possible flight itineraries, a user may select one of the flight itineraries and then obtain their seat and flight assignments based on the flight itinerary selected. Additionally, a confirmation, boarding passes, or the like, may be generated and output for use by the user.

In another embodiment of the present invention, the airline, at the time that the travel window, also referred to as a time window, is booked by the user, may determine the discounted price for the travel window based on the endpoints, data representing the flights, their yields, costs, average loading, and the like. The present invention then assigns a placeholder for the travel window booking on a flight, or series of flights, that meet the travel window and endpoint requirements and which, at the time of booking, represents the largest return for the airline. For example, the flight or flights that are the least loaded at the time of the booking of the travel window may be assigned the placeholder. This placeholder does not reserve a particular seat assignment on the flight or flights but reserves an amount of available capacity on the flight or flights. The placeholder is able to be shifted to other flights as the situation for the initial flight or flights and other flights change over time before the departure time.

As flights receive more reservations over time, or reservations are canceled, between the time point that the travel window was booked and the actual departure time, the placeholder is moved from one flight to another based on the changes in the situations of the available flights between the endpoints and which satisfy the booked travel window. The movement of the placeholder is based on a determination as to which flight assignment of the variable class booking would result in an overall highest return to the airline. Thus, for example, if the flight that the placeholder was originally associated with becomes more full, it may be more beneficial to move the placeholder from the originally assigned flight to another flight that has less loading. This increases the yield of the less loaded flight and releases capacity on the flight that is in higher demand and which is more likely to receive premium or at least higher priced reservations than obtained using the variable class booking.

The shifting of the placeholder from one flight, or set of flights, to another may be performed up to a time point at which the user indicates he/she must be able to obtain information about his/her assigned flight(s). For example, this may be 24 hours before departure or some other time period before departure that is selected by the user when booking the travel window. Thus, as situations on each flight or set of flights that meet the travel window requirements change, the placeholder for the travel window booking is shifted from one flight or set of flights to another in order to maximize the return to the airline. At the time of notification selected by the user, the placeholder is no longer allowed to be moved from flight to flight, however a flight and seat assignment is not reserved, i.e. a travel lane is not blocked.

When the user attempts to retrieve the information about his/her flight itinerary after the notification time, the user is informed of the flight or flights that have been selected to meet the travel window requirements initially booked by the user. In addition, if there are alternative flights that either meet the travel window requirements, or are outside the travel window requirements but are within a tolerance of the travel window requirements, these other options may be presented to the user with an additional cost or discounted amount associated with them. The additional cost and discounted amount may be determined based on the yields of the flight, the costs, loading, and other factors.

Moreover, the alternative flight itineraries that may be provided, if any, may be selected based on criteria established by the airline. That is, even though there may be available capacity on other flights that meet the travel window requirements within a predetermined tolerance, the airline may establish criteria that causes either all or some of these alternatives to not be provided to the user. Thus, even though alternative flights exist that meet the booked travel window requirements, there is no requirement that these alternatives or at least all of these alternatives be provided to the user.

If the user selects one of the optional flights, the flight itinerary is adjusted and the additional cost is charged to the user's account or the discounted amount is refunded to the user's account. If the user does not select one of the optional flights, the original flight itinerary that was selected by the present invention is maintained. Once accepted, the flight itinerary is reserved so that seats are reserved on the flights indicated in the flight itinerary and a travel lane is blocked. In this way, travel lanes for variable class bookings are kept fluid until shortly before the departure time. Thus, airlines are able to move passengers from flight to flight in an effort to maximize the return to the airline.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in accordance with the present invention;

FIG. 2 is an exemplary block diagram of a server computing device in accordance with the present invention;

FIG. 3 is an exemplary block diagram of a client computing device in accordance with the present invention;

FIG. 4 is an exemplary diagram illustrating the interaction of computing devices in accordance with one exemplary embodiment of the present invention;

FIG. 5 is a data flow diagram illustrating the flow of data between the computing devices illustrated in FIG. 4 in accordance with one exemplary embodiment of the present invention;

FIG. 6 is an exemplary diagram of an input interface through which user may book a travel window in accordance with one exemplary embodiment of the present invention;

FIG. 7 is an exemplary diagram of an interface through which a listing of possible flight itineraries satisfying a booked travel window may be provided and a user may select one of the listed possible flight itineraries to obtain a reservation the flights listed in the selected itinerary, in accordance with one exemplary embodiment of the present invention;

FIG. 8 is a flowchart outlining an exemplary operation of the present invention when booking a travel window;

FIG. 9 is a flowchart outlining an exemplary operation of the present invention when receiving a selection of a flight itinerary satisfying the travel window;

FIG. 10 is a data flow diagram illustrating the flow of data between the computing devices illustrated in FIG. 4 in accordance with one exemplary alternative embodiment of the present invention;

FIG. 11 is an exemplary diagram of an interface through which a selected flight itinerary is displayed and alternative flight itineraries may be listed for selection by a user in accordance with one exemplary alternative embodiment of the present invention; and

FIG. 12 is a flowchart outlining an exemplary operation of the present invention when selecting a flight itinerary to meet a previously booked travel window in accordance with one exemplary alternative embodiment of the present invention.

### DETAILED DESCRIPTION OF THE PREFERRED EMBODIMENT

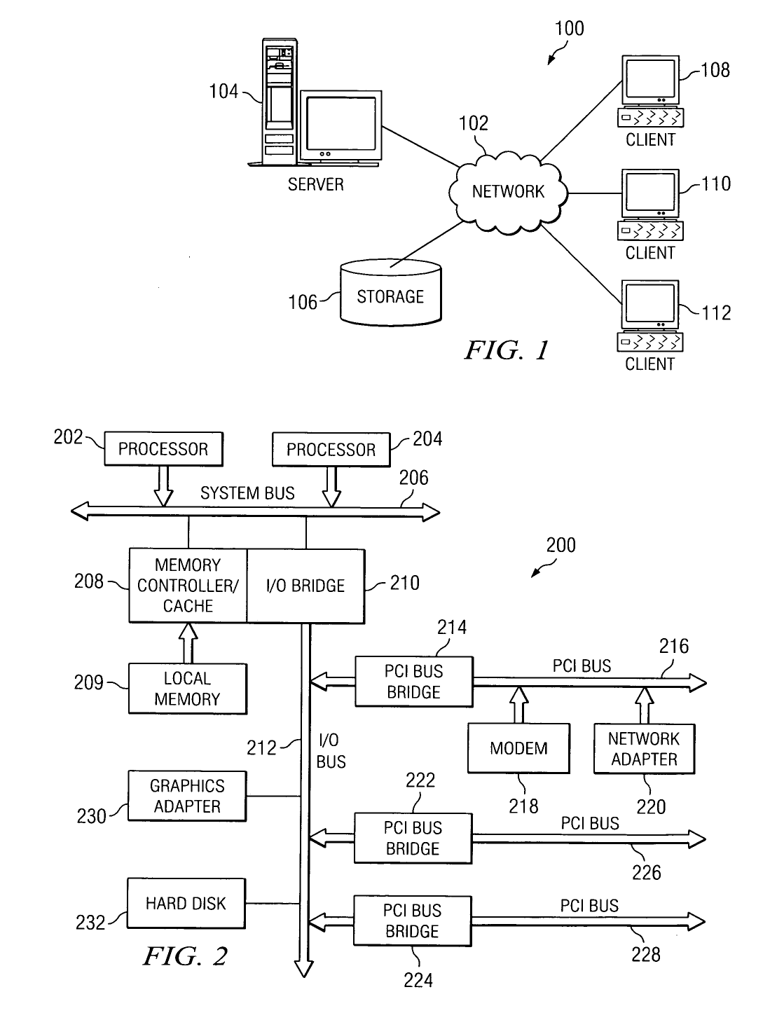

The present invention provides a system and method for airline variable routed capacity management. Because of the nature of the present invention, it is preferable that the invention be implemented in a distributed data processing system such that travelers may access flight travel information available from service providers via their own client computing devices. Therefore, the following description of FIGS. 1-3 is intended to provide an exemplary distributed data processing environment in which the present invention may be implemented. FIGS. 1-3 are not intended to assert or imply any limitation on the data processing environment in which the present invention may be implemented.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

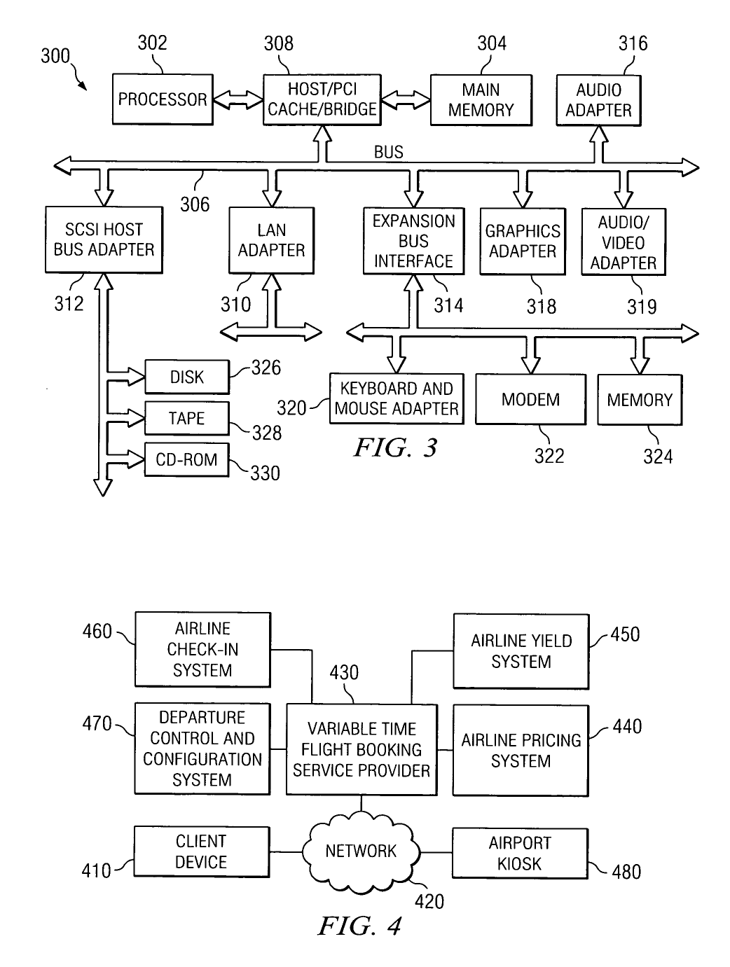

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned above, the present invention provides a system and method for providing an airline variable routed capacity management system. The system and method of the present invention provide a new class of travel referred to as the variable class (“V” class) or variable fare (“V” fare) flight service. This “V” class of flight service avoids blocking of travel lanes and instead permits booking of flights based on travel windows.

The “V” class of flight services is intended to provide a mechanism for reducing the amount of idle capacity of airlines while providing largely discounted travel costs to customers. Idle capacity is defined as flown available seat miles with no revenue attached to them. Capacity utilization or load factor, i.e. the amount of seats of a flight that are actually filled, combined with the yield, i.e. the revenue realized on an individual seat and on the leg of flight service, can make or break the airline profit equation. That is, if the capacity utilization or yield is too low, the airline will not be profitable.

Idle capacity poses a cost to the airline in terms of a portion of the fixed cost for flying the aircraft, e.g., salaries, landing fees, base fuel, overhead, depreciation, insurance, security, flight management and regulation. Idle capacity cannot be sold at breakeven prices because in addition to these fixed costs, there are variable costs as well that are associated with idle capacity. Thus, if airlines could sell idle capacity to cover their fixed and variable costs, they may be more profitable since the costs of idle capacity would be minimized.

Currently, idle capacity is sold through discount brokers as discussed above. Such sales of idle capacity are still based on identifying a lane, i.e. a seat on a leg of a flight, at a price. Such sales still require a reservation of a particular seat on a given flight for a class of service on particular dates. The airline blocks their inventory of available seats based on the reservation and thus, blocks the lane. Even with such discount brokers, idle capacity still exists for the unused inventory.

Consider the following example that illustrates the basis for the need of the present invention. Currently, a flight between Phoenix, Ariz. (PHX) and Houston, Tex. (HOU) on Southwest Airlines is priced at $150.00 going through El Paso, Tex. The trip takes 5 hours with one stop. No frequent flyer miles may be utilized and no food or reserved seats are provided. The load factor for both segments of the flight is approximately 80%.

A flight on American Airlines between Phoenix, Ariz. and Houston, Tex. is currently priced at $210.00 and goes through Dallas-Ft. Worth airport (DFW). The load factor from PHX to DFW is approximately 80 to 100% depending on the time of day. The load factor from DFW to HOU is approximately 50 to 90% depending on the time of day. Breakeven load factor, i.e. the load factor at which there is no profit and no loss for providing the flight, for American Airlines is approximately 70%.

Assume that the fixed cost per available seat on the PHX to DFW leg of the flight is $90 and the variable cost per available seat is $36. Also assume that the fixed cost per available seat on the DFW to HOU leg of the flight is $25 and the variable cost per available seat is $10.

It is known from market research that travelers are willing to pay approximately a 20% premium for service. Thus, the market value for the American Airlines flight service under the above scenario is approximately $195. The cost of service is $161 assuming a 70% load factor from PHX to DFW and the cost of service is $186 assuming a 50% load factor from DFW to HOU. The following table shows the profit and premiums paid for the above flight on American Airlines based on various prices and load factors based on the above exemplary scenario:

TABLE 1
Effects of Price and Load Factor on Profit and Premiums Paid

| PRICE | LOAD FACTOR | PROFIT | % PREMIUM |
|---|---|---|---|
| $195 | 75% | Breakeven | 30 |
| $180 | 80% | $900 | 20 |
| $170 | 85% | $1800 | 13 |

From Table 1, it is clear that if the load factor is increased, the price of a ticket on the flight may be reduced such that the traveler is paying a lower premium for the flight and the airline may realize a greater profit. In some cases, it may be possible to sell idle capacity at an individual ticket loss so as to increase the load factor making the flight as a whole more profitable. That is, while the individual idle capacity ticket may be sold at a loss, the affect of the price of the idle capacity ticket may not reduce the average ticket price for the flight significantly enough to offset the benefit obtained from increasing the load factor of the flight.

The present invention seeks to increase the load factor by minimizing the amount of idle capacity on flights. The present invention provides a mechanism for identifying the idle capacity on flights and offering this idle capacity at low cost to travelers in order to increase the load factor of the flight. In this way, the overall profitability of the flight is increased even though there may be small or even no profit obtained from the individual sale of the idle capacity ticket.

With the system and method of the present invention, a user, at time of booking, identifies only the departure and arrival airports, the dates of departure and return flights, and the travel window, i.e. the maximum amount of travel time the user is willing to endure to travel between the departure and arrival airports, or vice versa. At time of booking, there is no blocking of travel lanes since there is no reservation of seat assignments or flights but only the guarantee that the airline will provide some flight itinerary between the departure and arrival airports that meets the travel window on the departure and return dates. The particular flights or seat assignments are not identified and are not reserved.

At some time prior to the departure date, the user may again access the system of the present invention to obtain a listing of flight itineraries that meet the travel window on the dates, and between the cities, identified by user at booking. The identification of these flight itineraries may be made based on the criteria set by the booking of the travel window as well as information obtained from airline computing systems that identify available seats on flights, flight path information, travel time information, and the like.

This listing of available flight itineraries that meet the criteria set by the user during booking of the travel window may identify reduced prices or discounts to be applied to the price associated with these flight itineraries. The particular amount of reduction in the price or discount may be based, for example, on yield and pricing information obtained from airline computing systems.

In addition, flights that do not fall within the travel window but are within a particular tolerance of the travel window may be provided as options with additional discounts associated with them. In this way, the user may be “enticed” into adjusting their original travel criteria to take advantage of additional travel discounts.

Based on the listing of possible flight itineraries, a user may select one of the flight itineraries and then obtain their seat and flight assignments based on the flight itinerary selected. Additionally, a confirmation, boarding passes, or the like, may be generated and output for use by the user.

Thus, with the “V” class of flight service, the airline guarantees delivery of the passenger to the destination from the origin within “V” hours on the dates specified by the passenger. The “V” hours may not be the shortest or fastest route from the origin to the destination, however the passenger is provided with a discounted price to compensate for the difference between the shortest or fastest route and the actual route taken by the passenger. This discount may be determined based on yield and pricing information for the idle capacity being filled by the passenger accepting the “V” class of flight service.

With the present invention, the airlines still provide premium capacity reservations as blocked lanes, i.e. a traveler may still reserve a seat on a flight in order to block a lane of travel. However, in addition to this premium capacity, variable capacity is sold as a maximum variable time to travelers who wish to choose a “V” class flight service. With the “V” class flight service, the traveler may need to go through n number of transfers to get from an originating airport to a destination airport, however the amount of time spent in travel is governed by the maximum variable time selected by the traveler.

With the “V” class flight service of the present invention, idle capacity is filled close to departure time by passengers choosing their lanes from available alternative inventory of lanes. Since the idle capacity is filled close to departure, the ability to sell seats at the premium capacity rates or the discount broker rates is still provided until close to the time of departure of the flight.

At some time prior to departure of the flight, the traveler may request a listing of the available travel lanes meeting the time window, departure dates, and origin/destination airports. The airline may then identify flights that have idle capacity and that satisfy the time window designated by the traveler, or are within a tolerance of the time window designated by the traveler. The flights are then combined to create a plurality of flight itineraries from which the traveler may choose. Only at this time does the traveler actually block a travel lane through a selection of a travel lane from the list.

FIG. 4 is an exemplary diagram illustrating the interaction of computing devices in accordance with one exemplary embodiment of the present invention. The computing devices shown in FIG. 4 may be implemented in server computing devices, such as that illustrated in FIG. 2, and/or client computing devices, such as that shown in FIG. 3. FIG. 4 provides only an exemplary embodiment of the present invention and is not intended to assert or imply any limitation on the manner by which the present invention may be implemented.

As shown in FIG. 4, the computing devices used to implement this exemplary embodiment of the present invention include a variable time flight booking service provider 430, an airline pricing system 440, an airline yield system 450, an airline check-in system 460, and an airline departure control and configuration system 470. The systems 440-470 are in communication with the variable time flight booking service provider 430 and exchange information for use in booking “V” class flight service as well as blocking lanes of travel based on previously booked “V” class flight service.

The variable time flight booking service provider 430 communications with the systems 440-470 either through network 420, through a separate network, or through dedicated connections to these other systems. In addition, some or all of the systems 440-470 may be integrated with one another and may be integrated with the variable time flight booking service provider 430 without departing from the spirit and scope of the present invention.

The variable time flight booking service provider 430 communicates with client devices 410 and/or airport computer kiosks or terminals 480 via the network 420. The network 420 may be a local area network, a wide area network, the Internet, or the like. In a preferred embodiment, the network 420 is the Internet with the client devices 410 being personal computing devices located remotely from the variable time flight booking service provider.

In operation, a user of a client device 410 may log onto a web site associated with the variable time flight booking service provider 430 via the network 420 in order to obtain travel on a flight provided by an airline. Via the web site, the variable time flight booking service provider 430 may offer discounted tickets for “V” class flight service. For example, the airline may agree to a minimum of a 20% reduction in price for a flight in exchange for the user agreeing to accept a “V” class flight service in which the user is only guaranteed a time window rather than being guaranteed a particular seat on a particular flight between the origin and destination airports. There may be a minimum time window required in order to obtain the discounts, such as an 8 hour window. This 20% may be a minimum reduction in price with actual reductions in price being determined at the time that the flight itinerary is actually selected and a travel lane is blocked, as described hereafter.

If the user selects an option via the web site to accept a “V” class flight service, the user may then be provided with a web form through which the user may enter the necessary information for identifying the “V” class flight service that the user wishes to purchase. This information may include, for example, the airport of origin, the destination airport, whether the flight will be one way or round trip, a departure date, a return date, a desired travel window and a required time at which notification of the available travel lanes will be provided. Other personal information including billing information, contact information, name, address, and the like, may also be obtained.

The time window entered or selected by the user designates the maximum amount of time the user is willing to spend traveling from the origin airport to the destination airport. Thus, for example, while a flight from Houston, Tex. to Washington, D.C. may typically take 5 hours, a user may elect to spend up to 8 hours travel time in order to obtain a discounted ticket price to fly between Houston, Tex. and Washington, D.C. In this way, the airline may use this flexibility with travel time of 3 hours to identify flights having legs that would satisfy the flight between Houston, Tex. and Washington, D.C. that have idle capacity and then offer these flights as possibilities for meeting the 8 hour maximum travel time.

Once the user has finished providing all of the requisite information, the variable time flight booking service provider 430 may perform a verification of the origin and destination airports with the departure control and configuration system 470 to make sure that they provide service to those airports as well as verify the user's billing information in order to obtain payment for the booking of the time window. A confirmation number or other time window booking identifier may be provided to the user for later use when retrieving the list of available flight itineraries meeting the time window booking.

The required notification time entered by the user may be used to adjust the eventual price of the ticket for the “V” class flight service. That is, the closer to the departure time the user needs to have notification of the available flight itineraries, the greater the discount that may be offered. This is because the user is providing a larger amount of time to the airline to attempt to fill seats on flights meeting the time window criteria, at a premium ticket price. Users requiring notifications much earlier than the departure time, may not be provided with as much of a discount since they may be filling seats that could have otherwise been filled by travelers paying premium prices for guaranteed seat and flight assignments.

At some time later after having completed booking of the time window, the user may again log onto the variable time flight booking service provider 430. This subsequent log on may be via a client device 410 or may be via the airport computer kiosk or terminal 480. The user may then enter their confirmation number or other time window booking identifier to obtain access to a listing of available flight itineraries that meet the time window specified by the user at the time of booking. In addition, a security mechanism may be provided in the variable time flight booking service provider 430, such as a password verification system, in order to ensure that the user is the same person that booked the time window. Alternatively, the variable time flight booking service provider 430 may send a message to the client device 410 at the notification time specified by the user, identifying the list of flight itineraries that currently meet the time window booked by the user.

That is, either at the time that the user again logs onto the variable time flight booking service provider 430, or at the notification time specified by the user when booking the time window, the variable time flight booking service provider 430 compiles a list of flight itineraries that meet the time window requirements specified and booked by the user. In addition, other flight itineraries that are within a predetermined tolerance of the time window requirements may also be listed with a designation of an additional discount associated with these flight itineraries that do not quite meet the time window requirements. These additional discounts may be utilized as a way of enticing the user to be even more flexible in their travel arrangements in order to obtain an even larger discount on the cost of their flight.

The listing preferably provides details regarding departure and arrival times, the estimated travel time, pricing, and the amount of discount being provided. From this listing, the user may evaluate the amount of the discount being obtained versus the travel time, departure times, etc. The user may then select a flight itinerary from the listing in order to block a travel lane corresponding to the selected flight itinerary. In response, information is provided to the necessary systems 440-470 to block the travel lane and assign it to the user as well as update information regarding yield, pricing, and the like, for use by the airline company. In addition, boarding passes, itineraries, confirmations, or the like, may be generated and provided to the user.

The identification of flight itineraries meeting the travel window booked by the user may be performed by the variable time flight booking service provider 430 based on information retrieved from the other systems 440-470. For example, the variable time flight booking service provider 430 may obtain information regarding which flights for the airline have legs that either depart from or arrive at airports in such a pattern as to provide a complete flight between the designated origin airport and the destination airport within a total travel time corresponding to the travel window booked by the user, or within a predetermined tolerance of the travel window booked by the user, from the departure control and configuration system 470.

For example, if a user wishes to fly from Houston, Tex. to Washington D.C., the flights that have legs satisfying this flight path may include a flight originating in Houston, arriving at DFW airport and then continuing on to San Francisco, Calif. and a flight that originates at DFW airport, arriving at Washington D.C. Reagan International Airport, and then continuing on to Buffalo, N.Y. The combination of these two flights would satisfy the flight path from Houston to Washington, D.C. however, the flight time may or may not meet the time window requirements booked by the user.

The variable time flight booking service provider 430 identifies flights or combinations of flights that meet the flight path requirements associated with the time window booking and the travel time requirements designated by the time window booking. The variable time flight booking service provider 430 may then obtain seat availability information from the airline check-in system 460 to determine which of the identified flights currently have idle capacity that needs to be filled.

Having identified which flights satisfy the travel requirements associated with the booked time window and having determined which of these flights have idle capacity, the variable time flight booking service provider 430 retrieves yield and pricing information from the airline yield system 450 and the airline pricing system 440. This information is used to compute a discounted ticket price for each flight satisfying the booked time window requirements and having idle capacity. That is, from the yield information retrieved from the airline yield system 450, it can be determined a minimum average price for tickets on the designated flights based on a current load factor of the flight to break even and at what average price for tickets on the designated flights a desired profit may be obtained. Currently pricing information from the airline pricing system 440 may then be used to determine at what level of profit or loss these flights are currently operating. Based on this information, a price for the idle capacity may be calculated.

The flight information may then be combined into flight itineraries along with costs associated with the flight itineraries to generate a listing of flight itineraries that meet the booked travel window or are within a tolerance of the booked travel window. The difference between the prices associated with these flight itineraries and the current price for premium seating obtained from the airline pricing system 440 may then be used to calculate a discount amount. All of this information may be compiled and then presented to the user via a web page, graphical user interface, or the like, through which the user may select one of the flight itineraries to purchase. If there is no idle capacity (or if it is very limited, the system will simply report to the customer that the V class of fares is not available at the time window specified.

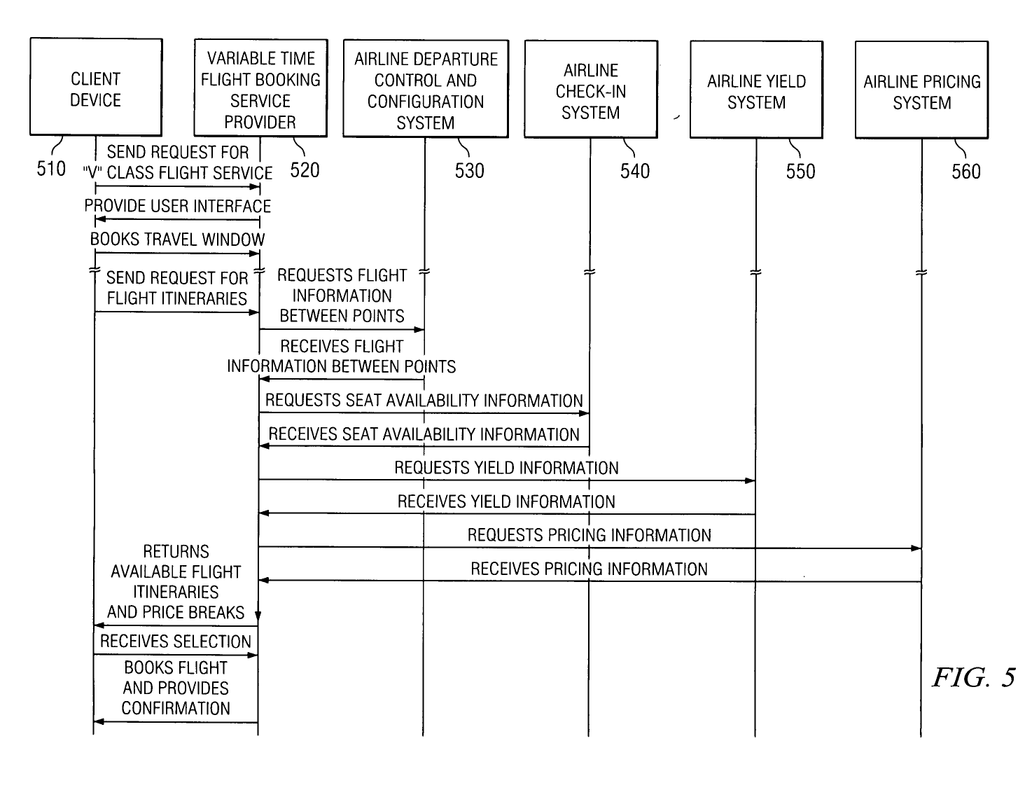

FIG. 5 is an exemplary data flow diagram illustrating the flow of data between the computing devices illustrated in FIG. 4 in accordance with one exemplary embodiment of the present invention. As shown in FIG. 5, the operation starts by a client device 510 sending a request for “V” class flight service to the variable time flight booking service provider 520. The variable time flight booking service provider 520 provides an interface to the client device 510 for entry of time window booking information. The user of the client device 510 enters the required information into the user interface and transmits the information to the variable time flight booking service provider 520 to thereby book the travel window desired by the user.

At some time later, the user logs onto the variable time flight booking service provider 520 and provides a confirmation or other identification of the travel window booking that was previously made. The variable time flight booking service provider 520 retrieves the time window booking information and then requests flight information from the departure control and configuration system 530. From this flight information, the variable time flight booking service provider 520 determines which flights satisfy the origin-to-destination flight path associated with the time window booking and the maximum travel time designated by the booked time window.

The variable time flight booking service provider 520 then requests the seat availability information for these flights from the airline check-in system 540. The airline check-in system 540 provides the current seat availability information for the identified flights to the variable time flight booking service provider 520 which then determines which of the flights meeting the travel window requirements have available idle capacity.

The variable time flight booking service provider 520 then sends a request for yield information and pricing information to the airline yield system 550 and airline pricing system 560. The yield information and pricing information is returned for the identified flights that meet the requirements of the booked travel window and that have available idle capacity. Based on this yield and pricing information, the variable time flight booking service provider 520 determines a price at which to sell tickets on the identified flights meeting the booked travel window and having available idle capacity. The variable time flight booking service provider 520 then generates flight itineraries and organizes them into a listing in a web page, graphical user interface, or the like. The variable time flight booking service provider 520 then provides this listing to the client device 510.

The user of the client device 510 views the listing and selects one of the flight itineraries from the listing. The associated price is charged to their account set forth in their billing information, which has been or is now provided, and a confirmation of the reservation of the flight(s) is returned. In addition, information is provided to the other systems 530-560 to update their internal records regarding the selected flight itinerary.

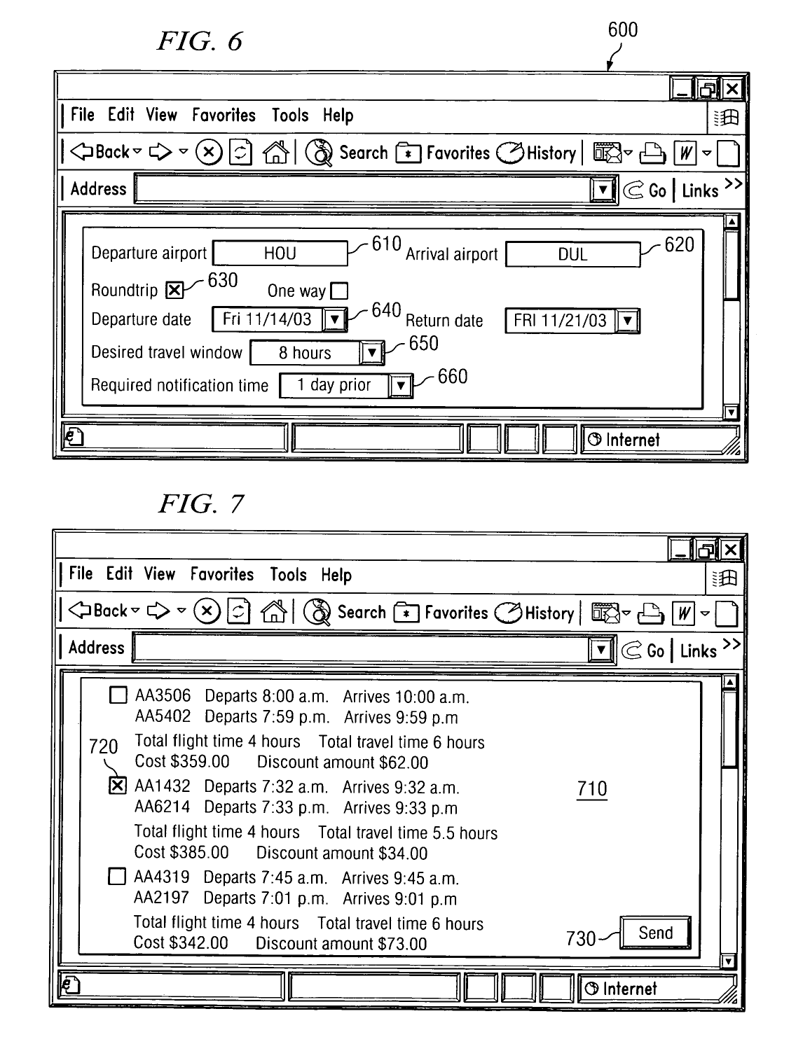

FIG. 6 is an exemplary diagram of an input interface through which user may book a travel window in accordance with one exemplary embodiment of the present invention. As shown in FIG. 6, the interface 600 includes a plurality of fields for entry of time window information for use in booking a time window on an airline for a future date. The fields illustrated in FIG. 6 are only intended to be exemplary and other fields may be used in conjunction with, or in replacement of, one or more of the fields illustrated in FIG. 6.

The illustrated interface 600 includes a first field 610 for entry of an originating airport, i.e. an airport from which the user wishes to depart, a field 620 for identifying the arrival airport, i.e. the destination airport to which the user wishes to fly, and fields 630 for designating whether the flight is one-way or round-trip. It should be noted that the above description of the present invention assumes a one-way trip, however the operation described above may be performed twice for round-trips. This may require that the user log onto the variable time flight booking service provider a first time to book the time window, a second time to secure a particular flight itinerary meeting the booked time window requirements for the trip to the destination airport, and then log on a third time to secure a particular flight itinerary meeting the booked time window requirements for the return trip from the destination airport back to the originating airport.

In addition, the interface 600 includes fields 640 for entry of a departure date and a return date. A field 650 is provided for entry of a desired travel window, i.e. a maximum amount of travel time the user is willing to accept. Entries into this field 650 may be verified to make sure that they are at least a minimum value. Alternatively, the entries in this field may be selected from a drop down menu that has a minimum value equal to the minimum value allowed for “V” class flight service. In addition, a field 660 may be provided for entry of a date on which notification of flight itineraries meeting the booked time window is desired.

FIG. 7 is an exemplary diagram of an interface through which a listing of possible flight itineraries satisfying a booked travel window may be provided and a user may select one of the listed possible flight itineraries to obtain a reservation the flights listed in the selected itinerary, in accordance with one exemplary embodiment of the present invention. Again, it should be appreciated that FIG. 7 is only exemplary and no limitation to the present invention is intended by the depiction in FIG. 7.

As shown in FIG. 7, the interface 700 includes a listing of flight itineraries 710 that meet the booked travel window requirements. These itineraries 710 preferably include information regarding the flight numbers, departure times, arrival times, total flight time, total travel time, price, amount of a discount associated with the itinerary, and the like. A selection box 720 is provided in association with these itineraries so that a user may select a flight itinerary from the list in order to block a travel lane.

The user preferably selects an appropriate selection box 720 using an input device and then selects a transmit button 730 for transmitting the selection to the variable time flight booking service provider. The variable time flight booking service provider then blocks the associated travel lane, sends a confirmation to the user (or generates appropriate boarding passes or the like), and then sends information to update airline computing systems regarding the blocked travel lane.

Thus, the present invention provides a system and method that permit variable routed capacity management. With the system and method of the present invention, users may book time windows rather than having to block travel lanes when they initially purchase flight services from an airline. At a later date, i.e. closer to the actual time of travel, the user may be presented with flight information of flights having idle capacity and which satisfy the travel window booked by the user. In this way, airlines are able to reduce the amount of idle capacity on their flights and the user is provided with largely discounted flight pricing.

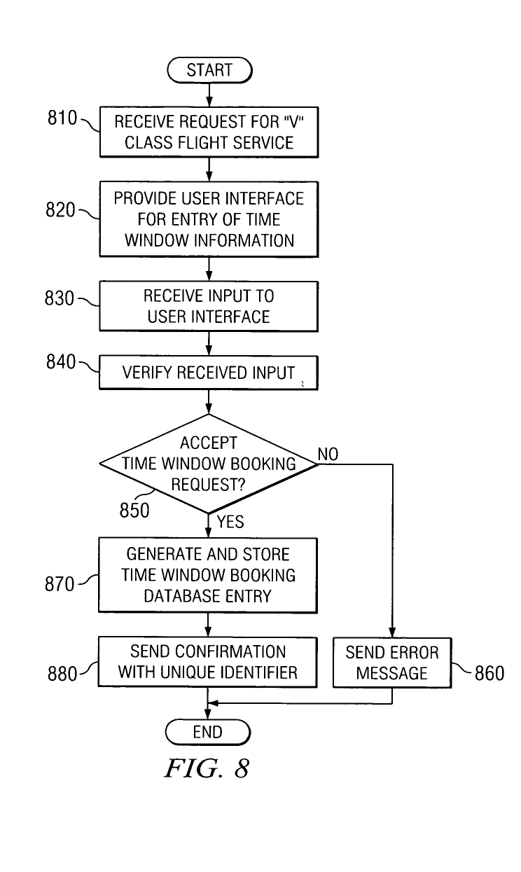

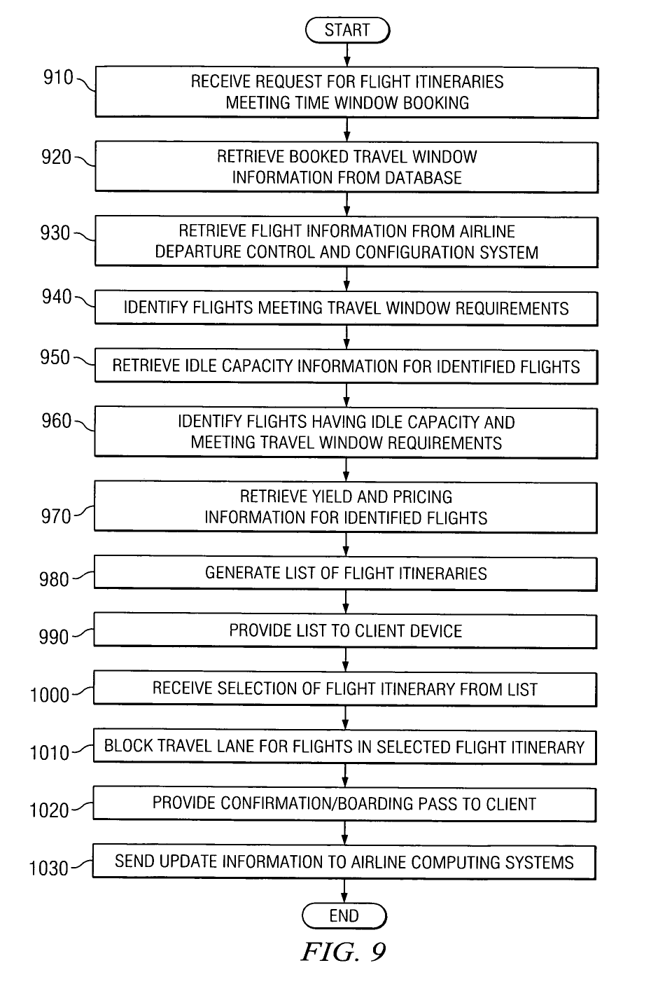

FIGS. 8 and 9 are flowcharts outlining an exemplary operation of the present invention when booking a travel window and then selecting a flight itinerary satisfying the travel window. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

FIG. 8 is a flowchart outlining an exemplary operation of the present invention when booking a time window. As shown in FIG. 8, the operation starts by receiving a request for “V” class flight service from a client device (step 810). A user interface for entry of time window requirements is provided to the user (step 820). Input into the user interface is then received from the client device as a time window booking request (step 830). The input into the user interface is verified to determine if there are any errors and if the desired time window requirements are achievable (step 840).

A determination is made as to whether to accept or reject the time window booking request (step 850). If the time window booking request is rejected, an error message is returned to the client (step 860) and the operation returns to step 820. If the time window booking request is accepted, the time window booking request information is used to generate a database entry that is stored in a booked time window database (step 870). A confirmation or other identifier is then returned to the client device (step 880) and the operation terminates.

FIG. 9 is a flowchart outlining an exemplary operation of the present invention when selecting a flight itinerary that satisfies a previously booked travel window. As shown in FIG. 9, the operation starts by receiving a request for a flight itinerary listing from a client device (step 910). Preferably, this request includes the confirmation or other identifier provided to the user at the time the travel window was booked. Additionally, security information may be provided for verification purposes.

The booked travel window information is retrieved from the booked travel window database (step 920) and flight information is retrieved from an airline departure control and configuration system (step 930). Flights meeting the requirements of the booked travel window are identified (step 940) and available idle capacity information for these flights is retrieved from the airline check-in system (step 950). Flights having idle capacity and meeting the requirements of the booked travel window are identified (step 960) and yield and pricing information is then retrieved for these identified flights from airline yield and pricing systems (step 970).

A list of flight itineraries is then generated based on the above information including information regarding the flights that meet the requirements of the booked time window and cost for purchasing a seat on these flights (step 980). The listing is provided to the client device (step 990) and a selection is received (step 1000). The selected flight itinerary is blocked (step 1010), a confirmation or boarding pass is provided to the client device (step 1020) and information is sent to the airline computing systems in order to update their internal records regarding the selected flight itinerary (step 1030). The operation then terminates.

In another embodiment of the present invention, the airline, at the time that the travel window, or time window, is booked by the user, may determine the discounted price for the travel window based on the endpoints, data representing the flights, their yields, costs, average loading, and the like. The present invention then assigns a placeholder for the travel window booking on a flight, or series of flights, that meet the travel window and endpoint requirements and which, at the time of booking, represents the largest return for the airline. For example, the flight or flights that are the least loaded at the time of the booking of the travel window may be assigned the placeholder. This placeholder does not reserve a particular seat assignment on the flight or flights but reserves an amount of available capacity on the flight or flights. The placeholder is able to be shifted to other flights as the situation for the initial flight or flights and other flights change over time before the departure time. Thus, the placeholder is a dynamic placeholder in that it is not affixed to any one flight or set of flights and may be moved fluidly from one flight or set of flights as circumstances dictate.

As flights receive more reservations over time, or reservations are canceled, between the time point that the travel window was booked and the actual departure time, the dynamic placeholder is moved from one flight to another based on the changes in the situations of the available flights between the endpoints and which satisfy the booked travel window. The movement of the dynamic placeholder is based on a determination as to which flight assignment of the variable class booking would result in an overall highest return to the airline. Thus, for example, if the flight that the placeholder was originally associated with becomes more full, it may be more beneficial to move the placeholder from the originally assigned flight to another flight that has less loading. This increases the yield of the less loaded flight and releases capacity on the flight that is in higher demand and which is more likely to receive premium or at least higher priced reservations than obtained using the variable class booking.

The shifting of the placeholder from one flight, or set of flights, to another may be performed up to a time point at which the user indicates he/she must be able to obtain information about his/her assigned flight(s). For example, this may be 24 hours before departure or some other time period before departure that is selected by the user when booking the travel window. Thus, as situations on each flight or set of flights that meet the travel window requirements change, the dynamic placeholder for the travel window booking is shifted from one flight or set of flights to another in order to maximize the return to the airline. At the time of notification selected by the user, the dynamic placeholder is no longer allowed to be moved from flight to flight, however a flight and seat assignment is not reserved, i.e. a travel lane is not yet blocked. The flight or flights that the dynamic placeholder is associated with are selected as the default flight itinerary for the previously booked travel window.

When the user attempts to retrieve the information about his/her flight itinerary after the notification time, the user is informed of the default flight or flights that have been selected to meet the travel window requirements initially booked by the user. In addition, if there are alternative flights that either meet the travel window requirements, or are outside the travel window requirements but are within a tolerance of the travel window requirements, these other options may be presented to the user with an additional cost or discounted amount associated with them, similar to the previously described embodiments. The additional cost and discounted amount may be determined based on the yields of the flight, the costs, loading, and other factors, as previously discussed.

Moreover, the alternative flight itineraries that may be provided, if any, may be selected based on criteria established by the airline. That is, even though there may be available capacity on other flights that meet the travel window requirements within a predetermined tolerance, the airline may establish criteria that causes either all or some of these alternatives to not be provided to the user. Thus, even though alternative flights exist that meet the booked travel window requirements, there is no requirement that these alternatives or at least all of these alternatives be provided to the user.

If the user selects one of the optional flights, the flight itinerary is adjusted and the additional cost is charged to the user's account or the discounted amount is refunded to the user's account. If the user does not select one of the optional flights, the original flight itinerary that was selected by the present invention, i.e. the default flight itinerary, is maintained. Once accepted, the flight itinerary is reserved so that seats are reserved on the flights indicated in the flight itinerary and a travel lane is blocked. In this way, travel lanes for variable class bookings are kept fluid until shortly before the departure time. Thus, airlines are able to move passengers from flight to flight in an effort to maximize the return to the airline while providing the user with a discounted fare.

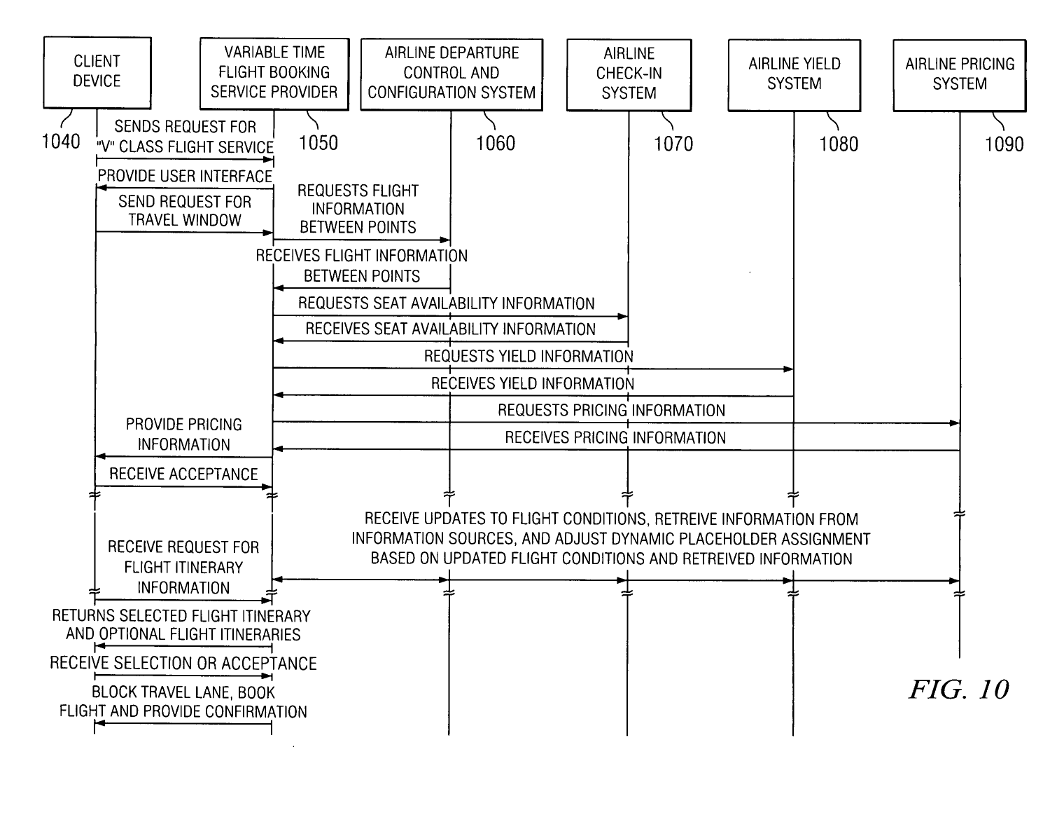

FIG. 10 is a data flow diagram illustrating the flow of data between the computing devices illustrated in FIG. 4 in accordance with one exemplary alternative embodiment of the present invention. As shown in FIG. 10, the operation starts with a user of a client device 1040 sending a request for a “V” class flight service to the variable time flight booking service provider 1050. The variable time flight booking service provider 1050 responds with a user interface through which the user of the client device 1040 may enter the originating and destination points, the acceptable time window for traveling, a notification time, and the like, to thereby generate a request for a travel window. The request is sent to the variable time flight booking service provider 1050 which then requests and receives information from various airline computing systems 1060-1090, e.g., flight information, seat availability information, yield information, pricing information, and the like.

Based on the information retrieved, the variable time flight booking service provider 1050 determines a price at which the requested travel window may be guaranteed to the user. This pricing information is provided to the user of the client device 1040 who may then either accept or reject the price. It is assumed for purposes of this description that the user accepts the price offered. Thereafter, a particular flight or flights are selected that meet the requested travel window requirements and which are a best candidate for associating with the request. A best candidate may be determined based on many different criteria such as yield, current loading, current costs, and the like. The best candidate may be, for example, the flight or flights that would result in a maximized return to the airline for offering the variable rate flight service to the user.

A dynamic placeholder is associated with the selected flight or flights. This dynamic placeholder reserves capacity of the flight or flights but does not block a travel lane on the selected flight or flights. That is, there is no reservation on a particular seat on a particular flight. The dynamic placeholder is allowed to be moved from one flight to another based on current conditions of the various flights that meet the previously booked travel window requirements. As conditions change on the various flights that meet the requirements of the previously booked travel window, the variable time flight booking service provider 1050 retrieves information from the information sources 1060-1090 for these flights and continues to update its selection of the best flight or flight(s) to be assigned to the user's booked travel window and the placeholder is moved accordingly.

When the current time equals the notification time, the dynamic movement of the placeholder is disabled and the flight or flights that are currently associated with the placeholder are selected as the default flight itinerary for the previously booked travel window. At that time, the variable time flight booking service provider 1050 may send information to the user at the client device 1040 indicating the selected flight or flights and any alternative flights, if any. The alternative flights may be determined in a similar manner as discussed above with regard to the other embodiments of the present invention. Alternatively, this information may be provided upon a request being received from the client device 1040.

From the selected flight(s) information and the alternative flight information, the user may either accept the selected flight(s) or may select an alternative flight. Any additional cost or reduction in cost will then be charged or credited to the user's account. The travel lane(s) associated with the flight(s) associated with either the default flight itinerary (if it was accepted) or a selected alternative flight itinerary, are then blocked, seat assignments are reserved, and a confirmation is provided to the user.

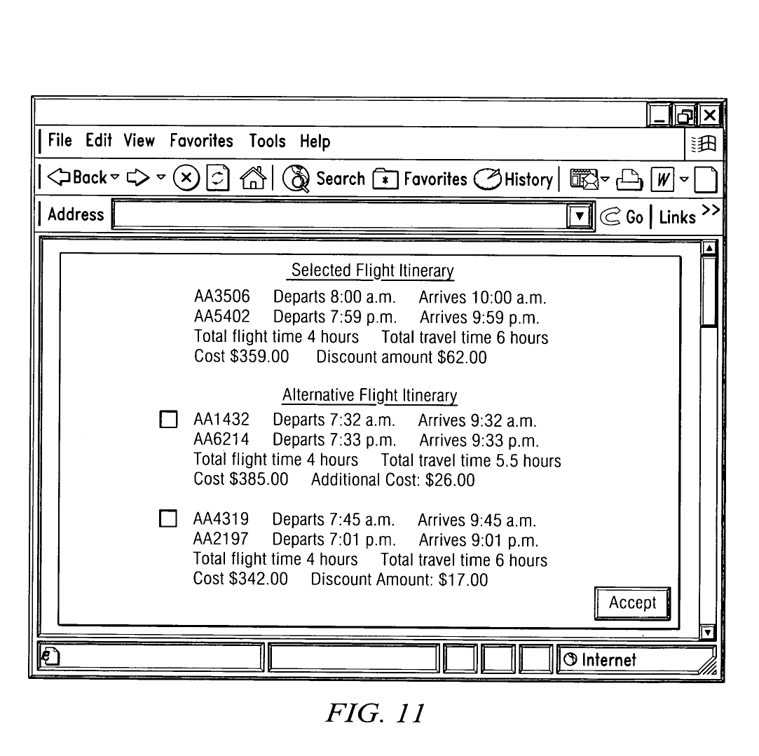

FIG. 11 is an exemplary diagram of an interface through which a selected flight itinerary is displayed and alternative flight itineraries may be listed for selection by a user in accordance with one exemplary alternative embodiment of the present invention. As shown in FIG. 11, the primary difference between this interface and the one depicted in FIG. 7 is that a default flight itinerary is provided and is the selected flight itinerary as long as no alternative flight itinerary is selected. Alternative flight itineraries may be provided at an additional cost or a reduced cost and may be selected by the user in order to override the default flight itinerary selection. In some embodiments, alternative flight itineraries may not be provided or the particular alternative flight itineraries that meet the requirements of the previously booked travel window, and which are to be provided as alternative selections, may be limited by criteria established by the airline. Thus, in some cases, the user may not be given any alternatives and must accept the flight itinerary selected by the present invention.

Thus, in this alternative embodiment, the present invention allows a user to book a travel window at an agreed upon price without a travel lane being blocked for the user. A dynamic placeholder is used to allow the present invention to dynamically change the flights that are selected to meet the previously booked travel window up until a notification time that was selected by the user. At this time, the flight(s) that are associated with the dynamic placeholder are selected as the flight itinerary for the previously booked travel window. Thus, the present invention allows the actual assignment of the user to a particular flight or flights to be performed by the automated system. Moreover, this assignment is kept fluid up until a short time before the booked departure time. In this way, the airline may shift flight assignments to maximize returns for an extended period of time so as to minimize unused capacity of flights and increase revenue.

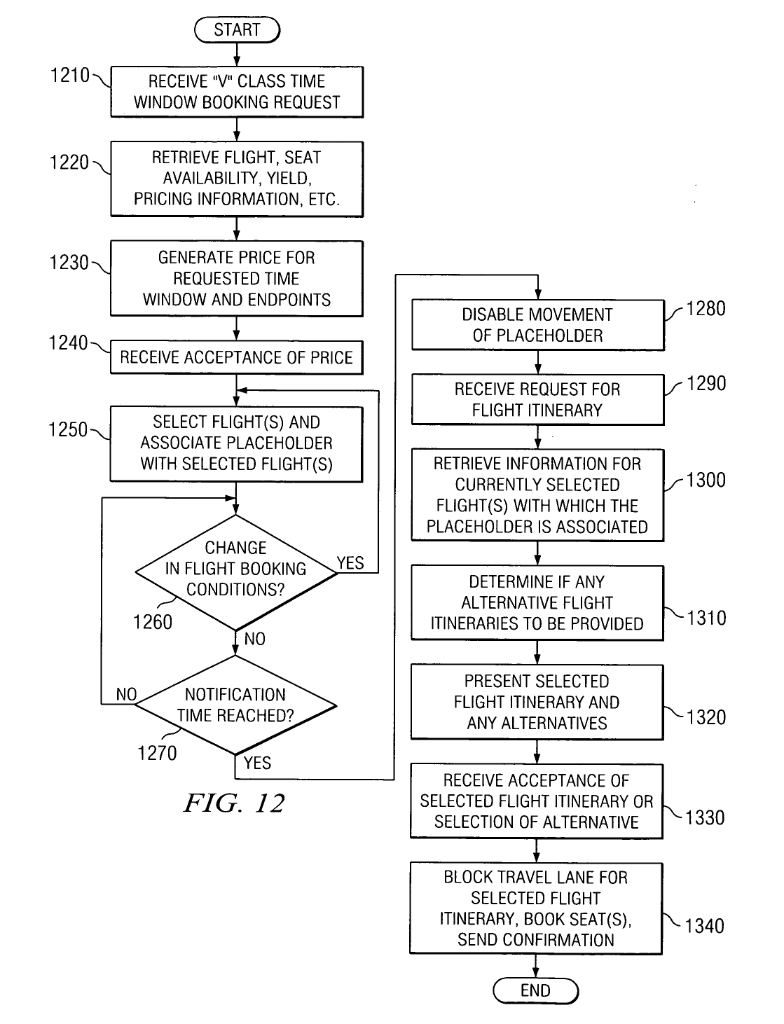

FIG. 12 is a flowchart outlining an exemplary operation of the present invention when selecting a flight itinerary to meet a previously booked travel window in accordance with one exemplary alternative embodiment of the present invention. As shown in FIG. 12, the operation starts by receiving a request for a “V” class time window booking (step 1210). Information is retrieved from various information providers (step 1220) and a price is generated based on the retrieved information and the requested time window booking (step 1230). Acceptance of the quoted price is then received (step 1240) and a flight or flights that meet the booked time window requirements and which are the best candidate for allocating to the user at the current time are selected (step 1250).

A determination is then made as to whether there are any changes in booking conditions for flights meeting the requirements of the previously booked travel window (step 1260). If so, the operation returns to step 1250 where the best candidate flight(s) are again selected taking into account this change in booking conditions. If there are no changes in the flight booking conditions, then a determination is made as to whether a notification time associated with the previously booked time window is reached (step 1270). If not, the operation returns to step 1260. Otherwise, the movement of the placeholder is disabled (step 1280).

Immediately, or upon receipt of a request (step 1290), information for the currently selected flight(s) with which the placeholder is associated is retrieved (step 1300). A determination is made as to whether there are any alternative flight itineraries that are to be provided (step 1310). The selected flight itinerary and any alternative flight itineraries are then provided to the user (step 1320). An acceptance of the selected flight itinerary or a selection of an alternative flight itinerary is received (step 1330). The travel land for the selected flight itinerary is then blocked, seats are assigned on the associated flights, and a confirmation is sent to the user (step 1340). The operation then terminates.

It should be noted that the above embodiments of the present invention have been directed to the securing of flight arrangements for traveling between an origin airport and a destination airport. However, the present invention is not limited to air travel. Rather, any passenger based travel is intended to be within the spirit and scope of the present invention. For example, the mechanisms and principles of the present invention may be equally applied to travel by train, ship, bus, or any other vehicle or mode of transportation in which passengers purchase travel services from a travel service provider. Thus, each flight, leg of a train ride, leg of a bus ride, or the like, may be referred to as a scheduled transportation service upon which the present invention may operate in the manner previously discussed above.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system, for obtaining transportation services for traveling between a point of origin and a destination, comprising:
receiving a request for transportation services from a client device;
receiving, from the client device, an identifier of an acceptable travel window, wherein the travel window identifies a maximum amount of time that a passenger is willing to spend traveling from the point of origin to the destination; and
providing a guarantee of transportation services from a transportation provider based on the identified acceptable travel window, wherein providing the guarantee of transportation services does not reserve a seat on any particular vehicle.

2. The method of claim 1, further comprising:
in response to a subsequent request from a client device, identifying one or more scheduled transportation services satisfying the travel window.

3. The method of claim 1, further comprising:
identifying one or more scheduled transportation services satisfying the travel window; and
providing, at a time remote from the time that the guarantee of transportation services is provided, one or more itineraries, that include one or more of the one or more scheduled transportation services, to the client device.

4. The method of claim 3, wherein the one or more itineraries include an itinerary of scheduled transportation services automatically selected for a user of the client device.

5. The method of claim 3, wherein the one or more itineraries include at least one of corresponding prices and corresponding discounts.

6. The method of claim 3, further comprising:
receiving a selection of a preferred itinerary of the one or more itineraries from the client device.

7. The method of claim 3, further comprising:
receiving a notification time from the client device indicating a time prior to a departure time at which notification of the one or more itineraries is to be made available to the client device.

8. The method of claim 7, wherein providing one or more itineraries to the client device includes sending an electronic notification to the client device at approximately the notification time.

9. The method of claim 3, wherein the one or more itineraries include itineraries that include one or more scheduled transportation services that meet the time window and itineraries that include one or more scheduled transportation services that are within a tolerance of the time window.

10. The method of claim 3, further comprising:
in response to a selection of an itinerary from the one or more itineraries, wherein the selection is performed either automatically or by a user of the client device, booking a travel lane for the user of the client device corresponding to the selected itinerary, wherein the booking of the travel lane is performed at a remote time from when the guarantee of transportation services is provided.

11. A computer program product in a computer readable medium for obtaining transportation services for traveling between a point of origin and a destination, comprising:
first instructions for receiving a request for transportation services from a client device;
second instructions for receiving, from the client device, an identifier of an acceptable travel window, wherein the travel window identifies a maximum amount of time that a passenger is willing to spend traveling from the point of origin to the destination; and
third instructions for providing a guarantee of transportation services from a transportation provider based on the identified acceptable travel window, wherein providing the guarantee of transportation services does not reserve a seat on any particular vehicle.

12. The computer program product of claim 11, further comprising:
fourth instructions for identifying one or more scheduled transportation services satisfying the travel window; and
fifth instructions for providing, at a time remote from the time that the guarantee of transportation services is provided, one or more itineraries, that include one or more of the one or more scheduled transportation services, to the client device.

13. The computer program product of claim 12, wherein the one or more itineraries include an itinerary of scheduled transportation services automatically selected for a user of the client device.

14. The computer program product of claim 12, wherein the one or more itineraries include at least one of corresponding prices and corresponding discounts.

15. The computer program product of claim 12, further comprising:
sixth instructions for receiving a selection of a preferred itinerary of the one or more itineraries from the client device.

16. The computer program product of claim 12, further comprising:
sixth instructions for receiving a notification time from the client device indicating a time prior to a departure time at which notification of the one or more itineraries is to be made available to the client device.

17. The computer program product of claim 16, wherein the fifth instructions for providing one or more itineraries to the client device include instructions for sending an electronic notification to the client device at approximately the notification time.

18. The computer program product of claim 12, wherein the one or more itineraries include itineraries that include one or more scheduled transportation services that meet the time window and itineraries that include one or more scheduled transportation services that are within a tolerance of the time window.

19. The computer program product of claim 12, further comprising:
sixth instructions for booking a travel lane for a user of the client device corresponding to a selected itinerary in response to a selection of an itinerary from the one or more itineraries, wherein the selection is performed either automatically or by a user of the client device, and wherein the booking of the travel lane is performed at a remote time from when the guarantee of transportation services is provided.

20. A system for obtaining transportation services for traveling between a point of origin and a destination, comprising:
means for receiving a request for transportation services from a client device;
means for receiving, from the client device, an identifier of an acceptable travel window, wherein the travel window identifies a maximum amount of time that a passenger is willing to spend traveling from the point of origin to the destination; and
means for providing a guarantee of transportation services from a transportation provider based on the identified acceptable travel window, wherein providing the guarantee of transportation services does not reserve a seat on any particular vehicle.
